(19) United States
(12) Patent Application Publication
(10) Pub. No.: US 2014/0374658 A1
(43) Pub. Date: Dec. 25, 2014

(54) LUMINESCENT MATERIALS DOPED WITH METAL NANO PARTICLES AND PREPARATION METHODS THEREFOR

(71) Applicants: Mingjie Zhou, Shenzhen (CN); Jun Liu, Shenzhen (CN); Rong Wang, Shenzhen (CN); Guitang Chen, Shenzhen (CN)

(72) Inventors: Mingjie Zhou, Shenzhen (CN); Jun Liu, Shenzhen (CN); Rong Wang, Shenzhen (CN); Guitang Chen, Shenzhen (CN)

(73) Assignees: OCEAN's KING LIGHING SCIENCE & TECHNOLOGY CO.,LTD, Shenzhen (GD); SHENZHIEN OCEAN'S KING LIGHTING ENGINEERING CO., LTD, Shenzhen (GD)

(21) Appl. No.: 14/372,743

(22) PCT Filed: Mar. 29, 2012
(86) PCT No.: PCT/CN2012/073261

§ 371 Date: Jul. 16, 2014

(51) Int. Cl. H01J 1/63; C09K 11/71; C09K 11/77

(52) U.S. Cl. CPC H01J 1/63; C09K 11/7778; C09K 11/7764; C09K 11/7738; C09K 11/7724; C09K 11/771; C09K 11/717; H01J 2329/20
USPC 252/301.4 P

(57) ABSTRACT

The invention belongs to the field of luminescent materials. Disclosed are luminescent materials doped with metal nano particles and preparation methods therefor. The luminescent materials doped with metal nano particles are represented by the chemical formula: A₅₋ₓ(PO₄)₂SiO₄:xRE@M_{y}, wherein @ is for coating, M is inner core, M is one metal nano particle selected from Ag, Au, Pt, Pd and Cu; RE is one or two ions selected from Eu, Gd, Tb, Tm, Sm, Ce, Dy and Mn; A is one or two elements selected from Ca, Sr, Ba, Mg, Li, Na and K; x is stoichiometric coefficient, 0<x≦1; y is molar ratio of M and Si, 0<y≦0.01. When luminescent materials doped with metal nano particles of the invention are excitated by electron beam, they have higher luminescent efficiency. The luminescent materials are good to be used in field emission light source devices.

### FIELD OF THE INVENTION

The invention relates to the field of luminescent materials, particularly to luminescent material doped with metal nano particles and preparation methods there for.

### BACKGROUND OF THE INVENTION

Currently, field emission cathode device has drawn considerable attention due to advantages in luminance, visual angle, response time, working temperature range and power consumption. A key factor to preparation of field emission display of high performances is to prepare fluorescent powder of excellent performance. As for sulfide series and oxysulfide series luminescent materials, they have relatively high luminance and electrical conductivity, but, under the large electron beam bombardment, they prone to decompose into sulfur, which can poison the tip of cathode and produce other precipitates covering the luminescent powders, thus reducing the luminous efficiency of luminescent powders. Oxide and silicate luminescent materials have good stability but the luminous efficiency is not high enough yet.

### SUMMARY OF THE INVENTION

One problem to be solved by the present invention is to provide luminescent material doped with metal nano particles that can improve luminescent efficiency of field emission device.

The technical solution of the present invention will be described below.

A luminescent material doped with metal nano particles represented by the chemical formula of A₅₋ₓ(PO₄)₂SiO₄:xRE@M_{y}; wherein @ denotes coating, M is inner core, M is metal nanoparticles selected from Ag, Au, Pt, Pd and Cu; RE is one or two ions selected from Eu, Gd, Tb, Tm, Sm, Ce, Dy and Mn; A is one or two elements selected from Ca, Sr, Ba, Mg, Li, Na and K; x is stoichiometric number in a range of 0<x≦1; y is molar ratio of M to Si, 0<y≦0.01. Preferably, x is in a range of 0.001<x≦0.5, y is in a range of 1×10⁻⁵≦y≦5×10⁻³.

Another problem to be solved by the present invention is to provide method for preparing the luminescent material doped with metal nano particles, comprising:

S1, at room temperature, dissolving PVP(polyvinylpyrrolidone) in deionized water to prepare Aqueous solution of PVP; then adding M collosol into the aqueous solution of PVP, stirring magnetically for 2 h to 24 h to obtain surface-treated M collosol solution;

S2, adding absolute ethanol and ammonia water successively into the surface-treated M collosol solution; then adding ethyl orthosilicate while stirring, performing reaction for 3 h to 10 h then separating and drying to obtain SiO₂@ M_{y} nanospheres; wherein volume ratio of absolute ethanol/deionized water/ammonia water/ethyl orthosilicate is in a range of 10:18 to 30:3 to 8:1 to 1.5;

S3, according to the stoichiometric ratio of corresponding elements in the chemical formula of A₅₋ₓ(PO₄)₂SiO₄:xRE@M_{y}, weighing compound containing A, soluble phosphate, compound containing RE, and SiO₂@M_{y} nanospheres obtained in S2, then grinding and mixing to obtain mixed powders;

S4, in air or in reducing atmosphere, calcining the mixed powders obtained from S3 at a constant temperature ranged from 800° C. to 1600° C. for 0.5 h to 15 h; cooling to room temperature, then taking out the calcined matter and grinding to obtain luminescent material doped with metal nano particles represented by the chemical formula of A₅₋ₓ(PO₄)₂SiO₄:xRE@M_{y};

wherein @ denotes coating, M is inner core, M is metal nanoparticles selected from Ag, Au, Pt, Pd and Cu; RE is one or two ions selected from Eu, Gd, Tb, Tm, Sm, Ce, Dy and Mn; A is one or two elements selected from Ca, Sr, Ba, Mg, Li, Na and K; x is stoichiometric number in a range of 0<x≦1; y is molar ratio of M to Si, 0<y≦0.01.

In S1 of the method for preparing the luminescent material doped with metal nano particles, the M collosol is prepared by the following steps:

mixing solution of salt containing M, assistant agent used for dispersing and reducing agent, reacting while stirring to obtain M collosol; wherein molar concentration of M collosol is in a range of 5×10⁻⁴ mol/L to 5×10⁻² mol/L.

In the solution of salt containing M, salt used as source of M is at least one of AgNO₃, AuCl₃·HCl·4H₂O, H₂PtCl₆·6H₂O, PdCl₂·2H₂O and Cu(NO₃)₂.

Assistant agent is at least one of polyvinylpyrrolidone, sodium citrate, cetyl trimethyl ammonium bromide, sodium dodecyl sulfate, and sodium dodecyl sulfonate; the assistant agent is added in an amount sufficient to obtain a concentration in M collosol in a range of 1×10⁻⁴ g/mL to 5×10⁻² g/mL;

Reducing agent is at least one of hydrazine hydrate, ascorbic acid, sodium citrate and sodium borohydride; molar ratio of reducing agent to M is in a range of 3.6:1 to 18:1.

In S1 of the method for preparing the luminescent material doped with metal nano particles, concentration of PVP in the aqueous solution of PVP is in a range of 0.005 g/mL to 0.1 g/mL.

In S3 of the method for preparing the luminescent material doped with metal nano particles, the compound containing A is selected from oxide of A, carbonate of A and oxalate of A; soluble phosphate is NH₄H₂PO₄ or (NH₄)₂HPO₄; the compound containing RE is selected from oxide of RE, carbonate of RE and oxalate of RE.

In S3 of the method for preparing the luminescent material doped with metal nano particles, the reducing atmosphere is mixed gases of N₂ and H₂, the volume ratio of H₂ to H₂ is 95:5.

In the method for preparing the luminescent material doped with metal nano particles, x is preferably in a range of 0.001≦x≦0.5, y is preferably in a range of 1×10⁻⁵≦y≦5×10⁻³.

The luminescent material doped with metal nano particles of the invention show relatively high luminescent efficiency under excitation by electron beam, thus can be used in field emission light source devices.

The method for preparing luminescent material doped with metal nano particles of the present invention is simple, high-quality, low-cost, and can be widely used in the manufacture of luminescent materials.

### BRIEF DESCRIPTION OF THE DRAWINGS

FIG. 1 is a flow diagram showing the preparation of luminescent material doped with metal nano particles;

FIG. 2 shows an emission spectrum of the luminescent material doped with Ag nano particles (Sr_{4.7}Li_{0.15}(PO₄)₂SiO₄:0.05Gd,³⁺0.1Tb³⁺@Ag_{1×10}⁻⁵) of Example 7, compared to the luminescent material without Ag nano particles (Sr_{4.7}Li_{0.15}(PO₄)₂SiO₄:0.05Gd³⁺, 0.1Tb³⁺) of Comparative Example 1. Curve a is an emission spectrum of the luminescent material without doping Ag nano particles (Sr_{4.7}Li_{0.15}(PO₄)₂SiO₄:0.05Gd³⁺, 0.1Tb³⁺) of Comparative Example 1, curve b is an emission spectrum of the luminescent material doped with Ag nano particles (Sr_{4.7}Li_{0.15}(PO₄)₂SiO₄:0.05Gd³⁺, 0.1Tb³⁺@Ag_{1×10}⁻⁵) of Example 7.

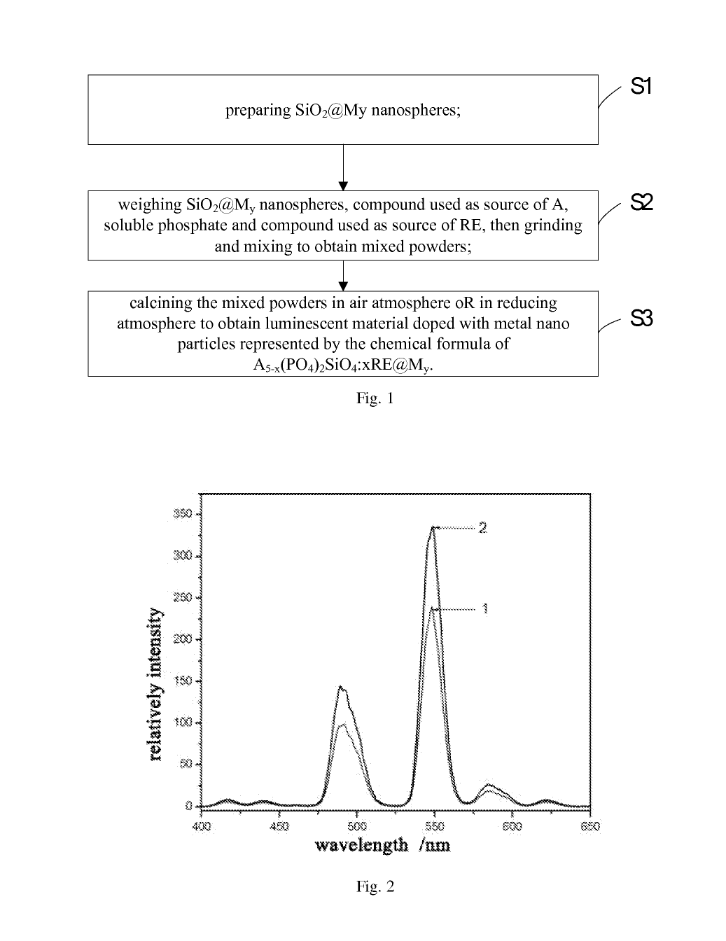

### DETAILED DESCRIPTION OF ILLUSTRATED EMBODIMENTS

In one embodiment, a luminescent material doped with metal nano particles is represented by the chemical formula of A₅₋ₓ(PO₄)₂SiO₄:xRE@M_{y}; wherein @ denotes coating, M is inner core, M is metal nanoparticles selected from Ag, Au, Pt, Pd and Cu; RE is one or two ions selected from Eu, Gd, Tb, Tm, Sm, Ce, Dy and Mn; A is one or two elements selected from Ca, Sr, Ba, Mg, Li, Na and K; x is stoichiometric number in a range of 0<x≦1; y is molar ratio of M to Si, 0<y≦0.01.Preferably, x is in a range of 0.001≦x≦0.5, y is in a range of 1×10⁻⁵≦y≦5×10⁻³.

As shown in FIG. 2, method for preparing luminescent material doped with metal nano particles comprises the following steps:

S1, preparing SiO₂@M_{y} nanospheres by StÖber method;

Firstly, solution of salt containing M is mixed and reacted with assistant agent used for dispersing and reducing agent to obtain M collosol. Specifically,

1) weighing salt containing M, assistant agent and PVP to make up aqueous solution of salt containing M, aqueous solution of assistant agent and aqueous solution of PVP;

2) adding aqueous solution of salt containing M and aqueous solution of PVP into deionized water while stirring, then dripping aqueous solution of assistant agent; performing the reaction for 5 min to 40 min to obtain M collosol; molar concentration of M collosol is in a range of 5×10⁻⁴ mol/L to 5×10⁻² mol/L;

Assistant agent is at least one of polyvinylpyrrolidone, sodium citrate, cetyl trimethyl ammonium bromide, sodium dodecyl sulfate, and sodium dodecyl sulfonate; the assistant agent is added in an amount sufficient to obtain a concentration in M collosol in a range of 1×10⁻⁴ g/mL to 5×10⁻² g/mL;

Reducing agent is at least one of hydrazine hydrate, ascorbic acid, sodium citrate and sodium borohydride; molar ratio of reducing agent to M is in a range of 3.6:1 to 18:1. The reducing agent is made up or diluted to an aqueous solution in which the concentration of reducing agent is in a range of 1 mol/L to 1×10⁻⁴ mol/L.

The salt containing M is at least one of AgNO₃, AuCl₃·HCl·4H₂O, H₂PtCl₆·6H₂O, PdCl₂·2H₂O and Cu(NO₃)₂, solvent is water or ethanol; the M is at least one of Ag, Au, Pt, Pd and Cu nanoparticle.

Secondly, the M collosol is added into aqueous solution of PVP. After surface treatment on M nanoparticle, SiO₂ nanospheres are coated by StÖber method to obtain SiO₂@M_{y} nanospheres. Specifically,

1) At room temperature, dissolving PVP in deionized water, then adding M collosol, stirring magnetically for 2 to 24 h to obtain surface-treated M collosol solution; concentration of PVP in the aqueous solution of PVP is in a range of 0.005 g/mL to 0.1 g/mL;

2) adding absolute ethanol and ammonia water successively into the surface-treated M and stirring thoroughly; then adding ethyl orthosilicate while stirring, performing reaction for 3 h to 10 h then separating and drying to obtain SiO₂@M_{y} nanospheres; wherein volume ratio of absolute ethanol, deionized water, ammonia water and ethyl orthosilicate is in a range of 10:18 to 30:3 to 8:1 to 1.5;

S2, according to the stoichiometric ratio of corresponding elements in the chemical formula of A₅₋ₓ(PO₄)₂SiO₄:xRE@M_{y}, weighing compound containing A, soluble phosphate, compound containing RE ,and SiO₂@M_{y} nanospheres obtained in S1, then grinding and mixing to obtain mixed powders; wherein an excess of NH₄H₂PO₄ or (NH₄)₂HPO₄ of 0-50 mol % (molar percent) can be used to avoid insufficient amount of reactant caused by decomposition and volatilization of NH₄H₂PO₄ or (NH₄)₂HPO₄ during the reaction.

S3, in air atmosphere or in reducing atmosphere of mixed gases of N₂ and H₂ in a volume ratio of 95:5, calcining the mixed powders obtained from S2 at a constant temperature ranged from 800° C. to 1600° C. for 0.5 h to 15 h; then cooling to room temperature, taking out the calcined matter and grinding to obtain luminescent material doped with metal nano particles represented by the chemical formula of A₅₋ₓ(PO₄)₂SiO₄:xRE@M.

wherein @ denotes coating, M is inner core, M is one of metal nanoparticles selected from Ag, Au, Pt, Pd and Cu; RE is one or two ions selected from Eu, Gd, Tb, Tm, Sm, Ce, Dy and Mn; A is one or two elements selected from Ca, Sr, Ba, Mg, Li, Na and K; x is stoichiometric number in a range of 0<x≦1; y is molar ratio of M to Si, 0<y≦0.01.

In S2 of the method for preparing the luminescent material doped with metal nano particles, the compound containing A is selected from oxide of A, carbonate of A and oxalate of A; soluble phosphate is NH₄H₂PO₄ or (NH₄)₂HPO₄; compound containing RE is selected from oxide of RE, carbonate of RE and oxalate of RE.

In S3 of the method for preparing the luminescent material doped with metal nano particles, the reducing atmosphere is mixed gases of N₂ and H₂ in a volume ratio of 95:5.

In the method for preparing the luminescent material doped with metal nano particles, x is preferably in a range of 0.001≦x≦0.5, y is preferably in a range of 1×10⁻⁵≦y≦5×10⁻³.

The luminescent material doped with metal nano particles of the invention show relatively high luminescent efficiency under excitation by electron beam, thus can be used in field emission light source devices.

The method for preparing luminescent material doped with metal nano particles of the present invention is simple, high-quality, low-cost, and can be widely used in the manufacture of luminescent materials.

Further description of the present invention will be illustrated, which combined with preferred embodiments and the drawings.

### Example 1

Luminescent material Sr₄(PO₄)₂SiO₄:Ce³⁺ doped with Pt nano particles, i.e. Sr₄(PO₄)₂SiO₄:Ce³⁺@Pt_{1×10}⁻³

1, 5.2 mg of chloroplatinic acid H₂PtCl₆·6H₂O was dissolved in 17 mL of ethanol. After the chloroplatinic acid completely dissolved, 8 mg of sodium citrate and 1.2 mg of sodium dodecyl sulfonate were added while stiffing, then slowly dripped into 0.4 mL of 1×10⁻³ mol/L ethanol solution of sodium borohydride prepared by dissolving 0.4 mg of sodium borohydride into 10 mL of ethanol. The reaction was performed for 5 min, followed by addition of 2.6 mL of 1×10⁻² mol/L solution of hydrazine hydrate. The reaction was continued for 40 min to obtain 30 mL of Pt nanoparticles collosol in which the concentration of Pt was 5×10⁻³ mol/L.

2, At room temperature, 0.60 g of PVP were weighed and dissolved in 6 mL of deionized water, followed by addition of 4 mL of the 5×10⁻³ mol/L Pt nanoparticles collosol. Surface-treated Pt nanoparticles collosol were obtained after magnetically stiffing for 18 h.

3, 18 mL of absolute ethanol, 3 mL of ammonia water and 1.0 mL of ethyl orthosilicate were successively added into the Pt nanoparticles collosol obtained previously while stiffing. The reaction was performed for 5 h, followed by centrifugal separation, washing and drying, SiO₂@Pt_{1×10}⁻³ nanospheres were obtained.

4, 3.3862 g of SrC₂O₄·2H₂O, 1.3806 g of NH₄H₂PO₄ (in excess of 50 mol %), 1.0886 g of Ce₂(C₂O₄)₃ and 0.2524 g of SiO₂@Pt were weighed and grinded in an agate mortar for mixing thoroughly to obtain mixed powders. The mixed powders were transferred to a corundum crucible, then reduced and calcined in tube furnace at 1600° C. for 0.5 h in the reducing atmosphere comprising 95 vol % of N₂ and 5 vol % of H₂. The obtained product was cooled to room temperature. Luminescent material Sr₄(PO₄)₂SiO₄:Ce³⁺ doped with Pt nano particles, i.e. Sr₄(PO₄)₂SiO₄:Ce³⁺@Pt_{1.25×10}⁻⁴ was obtained.

### Example 2

Luminescent material Sr_{4.9}Mg_{0.098}(PO₄)₂SiO₄:0.002Tm³⁺ doped with Ag nano particles, i.e. Sr_{4.9}Mg_{0.098}(PO₄)₂SiO₄:0.002Tm³⁺@Ag_{1.25×10}⁻⁴

1, 3.4 mg of silver nitrate AgNO₃ and 35.28 mg of sodium citrate were dissolved in 18.4 mL of deionized water while stiffing, then slowly dripped into 1.6 mL of 0.01 mol/L ethanol solution of sodium borohydride prepared by dissolving 3.8 mg of sodium borohydride into 10 mL of ethanol. The reaction was performed for 5 min while stirring to obtain 20 mL of Ag nanoparticles collosol in which the concentration of Ag was 1×10⁻³ mol/L.

2, At room temperature, 0.1 g of PVP were weighed and dissolved in 9.5 mL of deionized water, followed by addition of 0.5 mL of the 1×10⁻³ mol/L Ag nanoparticles collosol. Surface-treated Ag nanoparticles collosol were obtained after magnetically stirring for 2 h.

3, 25 mL of absolute ethanol, 6 mL of ammonia water and 1.0 mL of ethyl orthosilicate were successively added into the Ag nanoparticles collosol obtained previously while stirring. The reaction was conducted for 6 h, followed by centrifugal separation, washing and drying, SiO₂@Ag_{1.25×10}⁻⁴ nanospheres were obtained.

4, 2.8935 g of SrCO₃, 0.0331 g of MgCO₃, 1.1965 g of NH₄H₂PO₄ (in excess of 30 Mol %), 0.0021 g of Tm₂(CO₃)₃ and 0.2524 g of SiO₂@Ag were weighed and grinded in an agate mortar for mixing thoroughly to obtain mixed powders. The mixed powders were transferred to a corundum crucible, then calcined in muffle furnace at 1100° C. for 4 h in air atmosphere. The obtained product was cooled to room temperature. Luminescent material Sr_{4.9}Mg_{0.098}(PO₄)₂SiO₄:0.002Tm³⁺ doped with Ag nano particles, i.e. Sr_{4.9}Mg_{0.098}(PO₄)₂SiO₄:0.002Tm³⁺Ag_{1.25×10}⁻⁴ was obtained.

### Example 3

Luminescent material Ca₄Li_{0.5}(PO₄)₂SiO₄:0.5Sm³⁺ doped with Au nano particles, i.e. Ca₄Li_{0.5}(PO₄)₂SiO₄:0.5Sm³⁺@Au_{1×10}⁻³

1, 9.5 mg of sodium borohydride were dissolved in 10 mL of ethanol to obtain 10 mL of 0.02 mol/L ethanol solution of sodium borohydride for later use. 205.9 mg of chloroauric acid AuCl₃·HCl·4H₂O were dissolved in 7.5 mL of ethanol. After completely dissolved, 56 mg of sodium citrate and 24 mg of cetyl trimethyl ammonium bromide were added while stirring, followed by addition of 2.5 mL of ethanol solution of sodium borohydride prepared previously while magnetically stirring. The reaction was performed for 30 min to obtain 10 mL of Au nanoparticles collosol in which the concentration of Au was 5×10⁻² mol/L.

2, At room temperature, 0.18 g of PVP were weighed and dissolved in 9 mL of deionized water, followed by addition of 1 mL of the 5×10⁻³ mol/L Au nanoparticles collosol. Surface-treated Au nanoparticles collosol were obtained after magnetically stirring for 24 h.

3, 20 mL of absolute ethanol, 5 mL of ammonia water and 1.2 mL of ethyl orthosilicate were successively added into the Au nanoparticles collosol obtained previously while stirring. The reaction was conducted for 3 h, followed by centrifugal separation, washing and drying, SiO₂@Au_{1×10}⁻³ nanospheres were obtained.

4, 1.6014 g of CaCO₃, 0.0739 g of Li₂CO₃, 1.1965 g of NH₄H₂PO₄ (in excess of 30 Mol %), 0.3487 g of Sm₂O₃ and 0.3155 g of SiO₂@Au were weighed and grinded in an agate mortar for mixing thoroughly to obtain mixed powders. The mixed powders were transferred to a corundum crucible, then calcined in tube furnace at 800° C. for 10 h in air atmosphere. The obtained product was cooled to room temperature. Luminescent material Ca₄Li_{0.5}(PO₄)₂SiO₄:0.5Sm³⁺ doped with Au nano particles, i.e. Ca₄Li_{0.5}(PO₄)₂SiO₄:0.5Sm³⁺@Au_{1×10}⁻³ was obtained.

### Example 4

Luminescent material Ba_{4.8}Na_{0.1}(PO₄)₂SiO₄:0.1Eu²⁺ doped with Pd nano particles, i.e. Ba_{4.8}Na_{0.1}(PO₄)₂SiO₄:0.1Eu²⁺@Pd_{1×10}⁻²

1, 34.4 mg of palladium chloride PdCl₂·2H₂O were dissolved in 15 mL of deionized water. After the palladium chloride completely dissolved, 1.1 g of sodium citrate and 0.4 g of sodium dodecyl sulfate were added while stiffing, then slowly dripped into 5 mL of 0.1 mol/L ethanol solution of ascorbic acid. The reaction was performed for 20 min to obtain 20 mL of Pd nanoparticles collosol in which the concentration of Pd was 8×10⁻³ mol/L.

2, At room temperature, 0.20 g of PVP were weighed and dissolved in 5 mL of deionized water, followed by addition of 5 mL of the 8×10⁻³ mol/L Pd nanoparticles collosol. Surface-treated Pd nanoparticles collosol were obtained after magnetically stirring for 12 h.

3, 25 mL of absolute ethanol, 4 mL of ammonia water and 1.5 mL of ethyl orthosilicate were successively added into the Pd nanoparticles collosol obtained previously while stirring. The reaction was performed for 8 h, followed by centrifugal separation, washing and drying, SiO₂@Pd_{1×10}⁻² nanospheres were obtained.

4, 3.7888 g of BaCO₃, 0.0212 g of Na₂CO₃, 1.1965 g of NH₄H₂PO₄ (in excess of 30 mol %), 0.0704 g of Eu₂O₃ and 0.2524 g of SiO₂@Pd were weighed and grinded in an agate mortar for mixing thoroughly to obtain mixed powders. The mixed powders were transferred to a corundum crucible, then reduced and calcined in tube furnace at 1100° C. for 6 h in the reducing atmosphere comprising 95 vol % of N₂ and 5 vol % of H₂. The obtained product was cooled to room temperature. Luminescent material Ba_{4.8}Na_{0.1}(PO₄)₂SiO₄:0.1Eu²⁺ doped with Pd nano particles, i.e. Ba_{4.8}Na_{0.1}(PO₄)₂SiO₄:0.1Eu²⁺@Pd_{1×10}⁻² was obtained.

### Example 5

Luminescent material Sr_{4.999}(PO₄)₂SiO₄:0.001Mn²⁺ doped with Ag nano particles, i.e. Sr_{4.999}(PO₄)₂SiO₄:0.001Mn²⁺@Ag_{1×10}⁻⁵

1, 10 mL of 0.025 mol/L aqueous solution of AgNO₃, 10 mL of 0.025 mol/L aqueous solution of sodium citrate and 10 mL of 5 mg/mL aqueous solution of PVP were prepared separately by using 3.4 mg of AgNO₃, 0.0733 sodium citrate, 0.05 g of PVP. To 30 mL of deionized water, 2 mL of aqueous solution of AgNO₃ and 4 mL of aqueous solution of PVP were added while stiffing, heating at 100° C., then dripping 4 mL of aqueous solution of sodium citrate. The reaction was performed for 15 min to obtain 40 mL of Ag nanoparticles collosol in which the concentration of Ag was 5×10⁻⁴ mol/L.

2, At room temperature, 0.05 g of PVP were weighed and dissolved in 5 mL of deionized water, followed by addition of 5 mL of the 5×10⁻⁴ mol/L Ag nanoparticles collosol. Surface-treated Ag nanoparticles collosol were obtained after magnetically stirring for 18 h.

3, 30 mL of absolute ethanol, 8 mL of ammonia water and 1.5 mL of ethyl orthosilicate were successively added into the Ag nanoparticles collosol obtained previously while stirring. The reaction was performed for 10 h, followed by centrifugal separation, washing and drying, SiO₂@Ag_{1×10}⁻⁵ nanospheres were obtained.

4, 2.9526 g of SrCO₃, 1.1965 g of NH₄H₂PO₄ (in excess of 30 mol %), 0.3155 g of SiO₂@Ag and 0.0012 g of Mn(CH₃COO)₂·4H₂O were weighed and grinded in an agate mortar for mixing thoroughly to obtain mixed powders. The mixed powders were transferred to a corundum crucible, then reduced and calcined in tube furnace at 1100° C. for 5 h in the reducing atmosphere comprising 95 vol % of N₂ and 5 vol % of H₂. The obtained product was cooled to room temperature. Luminescent material Sr_{4.999}(PO₄)₂SiO₄:0.001Mn²⁺ doped with Ag nano particles, i.e. Sr_{4.999}(PO₄)₂SiO₄:0.001Mn²⁺@Ag_{1×10}⁻⁵ was obtained.

### Example 6

Luminescent material Sr_{4.9}K_{0.05}(PO₄)₂SiO₄:0.05Dy³⁺ doped with Cu nano particles, i.e. Sr_{4.9}K_{0.05}(PO₄)₂SiO₄:0.05Dy³⁺@Cu_{8×10}⁻³

1, 30 mg of copper nitrate Cu(NO₃)₂ were dissolved in 15 mL of deionized water. After the copper nitrate completely dissolved, 1.1 g of sodium citrate and 0.4 g of sodium dodecyl sulfate were added while stirring, then slowly dripped into 5 mL of 0.1 mol/L ethanol solution of ascorbic acid. The reaction was performed for 20 min to obtain 20 mL of Cu nanoparticles collosol in which the concentration of Cu was 8×10⁻³ mol/L.

2, At room temperature, 0.03 g of PVP were weighed and dissolved in 6 mL of deionized water, followed by addition of 4 mL of the 8×10⁻³ mol/L Cu nanoparticles collosol. Surface-treated Cu nanoparticles collosol were obtained after magnetically stirring for 24 h.

3, 20 mL of absolute ethanol, 5 mL of ammonia water and 1.2 mL of ethyl orthosilicate were successively added into the Cu nanoparticles collosol obtained previously while stirring. The reaction was performed for 4 h, followed by centrifugal separation, washing and drying, SiO₂@Cu_{8×10}⁻³ nanospheres were obtained.

4, 2.8935 g of SrCO₃, 0.0138 g of K₂CO₃, 1.0565 g of (NH₄)₂HPO₄, 0.2524 g of SiO₂@Cu and 0.0373 g of Dy₂O₃ were weighed and grinded in an agate mortar for mixing thoroughly to obtain mixed powders. The mixed powders were transferred to a corundum crucible, then calcined in tube furnace at 1000° C. for 15 h in air atmosphere. The obtained product was cooled to room temperature. Luminescent material Sr_{4.9}K_{0.05}(PO₄)₂SiO₄:0.05Dy³⁺ doped with Cu nano particles, i.e. Sr_{4.9}K_{0.05}(PO₄)₂SiO₄:0.05Dy³⁺@Cu_{8×10}⁻³ was obtained.

### Example 7

Luminescent material (Sr_{4.7}Li_{0.15}(PO₄)₂SiO₄:0.05Gd³⁺, 0.1Tb³⁺ doped with Ag nano particles, i.e. (Sr_{4.7}Li_{0.15}(PO₄)₂SiO₄:0.05Gd³⁺, 0.1Tb³+@Ag_{1×10}⁻⁵

1, 10 mL of 0.025 mol/L aqueous solution of AgNO₃, 10 mL of 0.025 mol/L aqueous solution of sodium citrate and 10 mL of 5 mg/mL aqueous solution of PVP were prepared separately by using 3.4 mg of AgNO₃, 0.0733 sodium citrate, 0.05 g of PVP. To 30 mL of deionized water, 2 mL of aqueous solution of AgNO₃ and 4 mL of aqueous solution of PVP were added while stiffing, then dripping 4 mL of aqueous solution of sodium citrate. The reaction was performed for 15 min to obtain 40 mL of 5×10⁻⁴ mol/L Ag nanoparticles collosol.

2, At room temperature, 0.08 g of PVP were weighed and dissolved in 5 mL of deionized water, followed by addition of 5 mL of the 5×10⁻⁴ mol/L Ag nanoparticles collosol. Surface-treated Ag nanoparticles collosol were obtained after magnetically stirring for 18 h.

3, 30 mL of absolute ethanol, 8 mL of ammonia water and 1.5 mL of ethyl orthosilicate were successively added into the Ag nanoparticles collosol obtained previously while stirring. The reaction was performed for 10 h, followed by centrifugal separation, washing and drying, spherical SiO₂@Ag_{1×10}⁻⁵ nanospheres were obtained.

4, 2.7754 g of SrCO₃, 1.2678 g of (NH₄)₂HPO₄ (in excess of 20 mol%), 0.0362 g of Gd₂O₃ and 0.0748 g of Tb₄O₇ and 0.3155 g of SiO₂@Ag were weighed and grinded in an agate mortar for mixing thoroughly to obtain mixed powders. The mixed powders were transferred to a corundum crucible, then reduced and calcined in tube furnace at 1050° C. for 5 h in the reducing atmosphere comprising 95 vol % of N₂ and 5 vol % of H₂. The obtained product was cooled to room temperature. Luminescent material (Sr_{4.7}Li_{0.15}(PO₄)₂SiO₄:0.05Gd³⁺, 0.1Tb³⁺ doped with Ag nano particles, i.e. (Sr_{4.7}Li_{0.15}(PO₄)₂SiO₄:0.05Gd³⁺, 0.1Tb³+@Ag_{1×10}⁻⁵ was obtained.

### Example 8

Luminescent material Sr_{4.9}K_{0.05}(PO₄)₂SiO₄:0.05Dy³⁺ doped with Pt/Au nano particles, i.e. Sr_{4.9}K_{0.05}(PO₄)₂SiO₄:0.05Dy³⁺@ Pt/Au_{1.7×10}⁻³

1, 10.7 mg of chloroauric acid (AuCl₃·HNO₃·4H₂O) and 13.56 mg of chloroplatinic acid (H₂PtCl₆·6H₂O) were dissolved in 28 mL of deionized water. After chloroauric acid and chloroplatinic acid dissolved completely, 22 mg of sodium citrate and 20 mg of PVP were weighed and added into the mixed solution obtained previously while magnetically stirring. 5.7 mg of freshly made sodium borohydride were dissolved in 10 mL of deionized water to obtain 10 mL of 1.5×10⁻² mol/L aqueous solution of sodium borohydride. While magnetically stirring, 4 mL of 1.5×10⁻² mol/L aqueous solution of sodium borohydride were added into the mixed solution obtained previously. Then the reaction was performed for 20 min to obtain 30 mL of Pt/Au nanoparticles collosol in which the molar concentration of total metal nanoparticles was 1.7×10⁻³ mol/L.

2, At room temperature, 0.03 g of PVP were weighed and dissolved in 6 mL of deionized water, followed by addition of 4 mL of the 1.7×10⁻³ mol/L Pt/Au nanoparticles collosol. Surface-treated Pt/Au nanoparticles collosol were obtained after magnetically stirring for 18 h.

3, 20 mL of absolute ethanol, 5 mL of ammonia water and 1.2 mL of ethyl orthosilicate were successively added into the Pt/Au nanoparticles collosol obtained previously while stirring. The reaction was performed for 4 h, followed by centrifugal separation, washing and drying, SiO₂@Pt/Au_{1.7×10}⁻³ nanospheres were obtained.

4, 2.8935 g of SrCO₃, 0.0138 g of K₂CO₃, 1.0565 g of (NH₄)₂HPO₄, 0.2524 g of SiO₂@Pt/Au and 0.0373 g of Dy₂O₃ were weighed and grinded in an agate mortar for mixing thoroughly to obtain mixed powders. The mixed powders were transferred to a corundum crucible, then calcined in tube furnace at 1000° C. for 15 h in air atmosphere. The obtained product was cooled to room temperature. Luminescent material Sr_{4.9}K_{0.05}(PO₄)₂SiO₄:0.05Dy³⁺ doped with Cu nano particles, i.e. Sr_{4.9}K_{0.05}(PO₄)₂SiO₄:0.05Dy³⁺@Cu_{8×10}⁻³ was obtained.

### Comparative Example 1

Luminescent material of (Sr_{4.7}Li_{0.15}(PO₄)₂SiO₄:0.05Gd³⁺,0.1Tb³⁺

1, at room temperature, 0.08 g of PVP was dissolved in 5 mL of deionized water, stirred magnetically for 18 h. Then 30 mL of absolute ethanol, 8 mL of ammonia water and 1.5 mL of ethyl orthosilicate were added while stirring. The reaction was performed for 10 h, followed by centrifugal separation, washing and drying, spherical SiO₂ nanospheres were obtained.

2, 2.7754 g of SrCO₃, 1.2678 g of (NH₄)₂HPO₄ (in excess of 20 mol %), 0.0362 g of Gd₂O₃ and 0.0748 g of Tb₄O₇ and 0.3155 g of SiO₂ were weighed and grinded in an agate mortar for mixing thoroughly to obtain mixed powders. The mixed powders were transferred to a corundum crucible, then reduced and calcined in tube furnace at 1050° C. for 5 h in the reducing atmosphere comprising 95 vol % of N₂ and 5 vol % of H₂. The obtained product was cooled to room temperature. Luminescent material (Sr_{4.7}Li_{0.15}(PO₄)₂SiO₄:0.05Gd³⁺, 0.1Tb³⁺ doped with Ag nano particles, i.e. (Sr_{4.7}Li_{0.15}(PO₄)₂SiO₄:0.05Gd³⁺, 0.1Tb³⁺ was obtained.

FIG. 2 shows an emission spectrum of the luminescent material doped with Ag nano particles (Sr_{4.7}Li_{0.15}(PO₄)₂SiO₄:0.05Gd³⁺, 0.1Tb³+@Ag_{1×10}⁻⁵) of Example 7, compared to the luminescent material without Ag nano particles (Sr_{4.7}Li_{0.15}(PO₄)₂SiO₄:0.05Gd³⁺, 0.1Tb³⁺) of Comparative Example 1. Curve 1 is an emission spectrum of the luminescent material without doping Ag nano particles (Sr_{4.7}Li_{0.15}(PO₄)₂SiO₄:0.05Gd³⁺, 0.1Tb³±) of Comparative Example 1, curve 2 is an emission spectrum of the luminescent material doped with Ag nano particles (Sr_{4.7}Li_{0.15}(PO₄)₂SiO₄:0.05Gd³⁺, 0.1Tb³+@Ag_{1×10}⁻⁵) of Example 7.

As shown in FIG. 2, under the excitation by cathode ray at 5 KV, the emission peak shown at 545 nm, luminescent intensity of the luminescent material doped with Ag nano particles is increased by 45%, compared to the luminescent material without Ag nanoparticles.

While the present invention has been described with reference to particular embodiments, it will be understood that the embodiments are illustrative and that the invention scope is not so limited. Alternative embodiments of the present invention will become apparent to those having ordinary skill in the art to which the present invention pertains. Such alternate embodiments are considered to be encompassed within the spirit and scope of the present invention. Accordingly, the scope of the present invention is described by the appended claims and is supported by the foregoing description.

1. A luminescent material doped with metal nano particles represented by the chemical formula of A₅₋ₓ(PO₄)₂SiO₄:xRE@M_{y}; wherein @ denotes coating, M is inner core, M is at least one of metal nanoparticles selected from Ag, Au, Pt, Pd and Cu; RE is one or two ions selected from Eu, Gd, Tb, Tm, Sm, Ce, Dy and Mn; A is one or two elements selected from Ca, Sr, Ba, Mg, Li, Na and K; x is stoichiometric number in a range of 0<x≦1; y is molar ratio of M to Si, 0<y≦0.01.

2. The luminescent material doped with metal nano particles according to claim 1, wherein x is in a range of 0.001≦x≦0.5, y is in a range of 1×10⁻⁵≦y≦5×10⁻³.

3. A method for preparing luminescent material doped with metal nano particles, comprising:
S1, at room temperature, dissolving PVP in deionized water to prepare aqueous solution of PVP; then adding M collosol into the aqueous solution of PVP, stirring magnetically for 2 h to 24 h to obtain surface-treated M collosol solution;
S2, adding absolute ethanol and ammonia water successively into the surface-treated M collosol solution; then adding ethyl orthosilicate while stirring, performing reaction for 3 h to 10 h then separating and drying to obtain SiO₂@M_{y} nanospheres; wherein volume ratio of absolute ethanol, deionized water, ammonia water and ethyl orthosilicate is in a range of 10:18 to 30:3 to 8:1 to 1.5;
S3, according to the stoichiometric ratio of corresponding elements in the chemical formula of A₅₋ₓ(PO₄)₂SiO₄:xRE@M_{y}, weighing compound containing A, soluble phosphate, compound containing RE, and SiO₂@M_{y} nanospheres obtained in S2, then grinding and mixing to obtain mixed powders;
S4, in air or in reducing atmosphere, calcining the mixed powders obtained from S3 at a constant temperature ranged from 800° C. to 1600° C. for 0.5 h to 15 h; then cooling to room temperature, taking out the calcined matter and grinding to obtain luminescent material doped with metal nano particles represented by the chemical formula of A₅₋ₓ(PO₄)₂SiO₄:xRE@M_{y};
wherein @ denotes coating, M is inner core, M is at least one of metal nanoparticles selected from Ag, Au, Pt, Pd and Cu; RE is one or two ions selected from Eu, Gd, Tb, Tm, Sm, Ce, Dy and Mn; A is one or two elements selected from Ca, Sr, Ba, Mg, Li, Na and K; x is stoichiometric number in a range of 0<x≦1; y is molar ratio of M to Si, 0<y≦0.01.

4. The method for preparing luminescent material doped with metal nano particles according to claim 3, wherein the M collosol in S1 is prepared by the following steps:
mixing solution of salt containing M, assistant agent used for dispersing and reducing agent, reacting while stirring to obtain M collosol; wherein molar concentration of M collosol is in a range of 5×10⁻⁴ mol/L to 5×10⁻² mol/L.

5. The method for preparing luminescent material doped with metal nano particles according to claim 4, wherein in the solution of salt containing M, salt containing M is at least one of AgNO₃, AuCl₃·HCl·4H₂O, H₂PtCl₆·6H₂O, PdCl₂·2H₂O and Cu(NO₃)₂.

6. The method for preparing luminescent material doped with metal nano particles according to claim 4, wherein assistant agent is at least one of polyvinylpyrrolidone, sodium citrate, cetyl trimethyl ammonium bromide, sodium dodecyl sulfate and sodium dodecyl sulfonate; the assistant agent is added in an amount sufficient to obtain a concentration in M collosol in a range of 1×10⁻⁴ g/mL to 5×10⁻² g/mL; reducing agent is at least one of hydrazine hydrate, ascorbic acid, sodium citrate and sodium borohydride; molar ratio of reducing agent to M is in a range of 3.6:1 to 18:1.

7. The method for preparing luminescent material doped with metal nano particles according to claim 3, wherein in S1, concentration of PVP in the aqueous solution of PVP is in a range of 0.005 g/mL to 0.1 g/mL.

8. The method for preparing luminescent material doped with metal nano particles according to claim 3, wherein in S3, the compound containing A is selected from oxide of A, carbonate of A and oxalate of A; soluble phosphate is NH₄H₂PO₄ or (NH₄)₂HPO₄; he compound containing RE is selected from oxide of RE, carbonate of RE and oxalate of RE.

9. The method for preparing luminescent material doped with metal nano particles according to claim 3, wherein in S4, the reducing atmosphere is mixed gases of N₂ and H₂ in a volume ratio of 95:5.

10. The method for preparing luminescent material doped with metal nano particles according to claim 3, wherein x is in a range of 0.001≦x≦0.5, y is in a range of 1×10⁻⁵≦y≦5×10⁻³.

11. The method for preparing luminescent material doped with metal nano particles according to claim 4, wherein x is in a range of 0.001≦x≦0.5, y is in a range of 1×10⁻⁵≦y≦5×10⁻³.

12. The method for preparing luminescent material doped with metal nano particles according to claim 5, wherein x is in a range of 0.001≦x≦0.5, y is in a range of 1×10⁻⁵≦y≦5×10⁻³.

13. The method for preparing luminescent material doped with metal nano particles according to claim 6, wherein x is in a range of 0.001≦x≦0.5, y is in a range of 1×10⁻⁵≦y≦5×10⁻³.

14. The method for preparing luminescent material doped with metal nano particles according to claim 7, wherein x is in a range of 0.001≦x≦0.5, y is in a range of 1×10⁻⁵≦y≦5×10⁻³.

15. The method for preparing luminescent material doped with metal nano particles according to claim 8, wherein x is in a range of 0.001≦x≦0.5, y is in a range of 1×10⁻⁵≦y≦5×10⁻³.

16. The method for preparing luminescent material doped with metal nano particles according to claim 9, wherein x is in a range of 0.001≦x≦0.5, y is in a range of 1×10⁻⁵≦y≦5×10⁻³.
